(19) United States
(12) Patent Application Publication
(10) Pub. No.: US 2003/0001395 A1
(43) Pub. Date: Jan. 2, 2003

(54) Device for latching and unlatching a removeable cover on a box

(75) Inventors: Philippe Barthelet, Bois-Colombes (FR); Gilles Durand, Eragny (FR); Yves Jouffret, Gonesse (FR); Oliver Lautrec, Gennevilliers (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/179,235

(22) Filed: Jun. 26, 2002

(30) Foreign Application Priority Data
Jun. 29, 2001 (FR) 01 08 629

(51) Int. Cl. E05C 1/10

(52) U.S. Cl. 292/175

(57) ABSTRACT

The present invention provides a device for latching and unlatching a removable cover referred to as a “removable element” on a box referred to as a “fixed element”, the device comprising a latch provided on one of the elements and slidable between a latched position in which one end of the latch is in contact with the other element and unlatched position in which said end is not in contact with the other element, said latch having a gripping surface enabling it to be caused to slide. According to the invention, it has means for locking the latch in the unlatched position, at least until the cover is moved.

The present invention relates to a device for latching and unlatching a removable cover on a box.

More precisely, the invention relates to a device for latching and unlatching a removable cover referred to as a “removable element” on a box referred to as a “fixed element”, the device comprising a latch provided on one of the elements and slidable between a latched position in which one end of the latch is in contact with the other element and unlatched position in which said end is not in contact with the other element, said latch having a gripping surface enabling it to be caused to slide.

### BACKGROUND OF THE INVENTION

Such latch(es) are commonly used, for example to close battery compartments in domestic appliances and in portable telephones that are designed to receive a battery unit.

In a known embodiment, such a latch is of the slider button type, sliding parallel to the plane of the cover and urged towards a latched position by a compression spring secured to the latch-carrying element. Thus in order to open or remove the cover, it is necessary to slide the latch against the force of the spring and to hold it in an unlatched position while simultaneously moving the cover.

In another known embodiment, the latch is of the press button type sliding perpendicularly to the plane of the cover and acting by deforming the latch which is carried on a blade of plastics material. To open or remove the cover, it is then necessary to press the latch against the force of said plastics material blade and to hold it in an unlatched position while simultaneously removing the cover.

That prior art is not very ergonomic because it requires the user to perform two actions simultaneously.

### OBJECTS AND SUMMARY OF THE INVENTION

The present invention solves this problem by providing the latch with a stable unlatched state.

To do this, according to the invention, the device includes means for locking the latch in its unlatched position, at least until the cover has been moved.

Specifically, the invention provides means for locking the latch in the unlatched position until the cover has been moved, and the locking means comprises a resilient element secured to one of the elements and suitable, in the unlatched position, for engaging in a locking cavity provided in the other element. This stable state is preferably temporary and said locking means is deactivated as soon as the cover has been moved.

In this way, the cover is closed merely by being put back into place, without manipulating the latch.

In a preferred embodiment, the cover is moved by pivoting about its end remote from the latch, the latch is slidable parallel to the plane of the cover and said means is constituted by a spring arrangement.

In a first variant, said resilient element is fixed to the box and is of a shape such as to enable the latch to slide from the latched position to the unlatched position in which it engages in a cavity formed in the cover.

Preferably, said resilient element is a blade and an end of the blade is jammed in a portion that is secured to the box, the blade being curved in shape so as to be received in the compressed condition beneath the cover, and presenting a folded portion constituting a projection extending towards the cover, its other end being free.

In a second variant, said resilient element is secured to the cover and is of a shape such as to allow the latch to slide from the latched position to the unlatched position in which it engages in a cavity formed in the box.

Under such circumstances, and preferably, said resilient element urges the latch towards its latched position until its reaches the unlatched position.

Preferably, said resilient element is a spring blade, and one end of said blade is secured to a second spring blade perpendicular to the travel direction of the latch when it is unstressed, and in abutment against two studs arranged on the cover, and said first-mentioned blade is of a curved shape so as to be received in a compressed configuration beneath the cover and presents a folded portion forming a projection directed towards the box, its end being free.

In all circumstances, the presser spring secured to the cover can optionally urge the latch towards the latched position.

The invention also provides a portable telephone fitted with a latching and unlatching device as specified above, said removable element being the cover of a compartment forming said fixed element and intended to receive a battery.

### BRIEF DESCRIPTION OF THE DRAWINGS

The invention is described below in greater detail with reference to figures that merely show preferred embodiments of the invention.

FIG. 1 is a longitudinal section view of a first embodiment of the device of the invention, in the latched position.

FIG. 2 is an identical section view in the unlatched position.

FIG. 3 is an identical section view to a different scale showing the cover in its displaced position.

FIGS. 4A and 4B are a diagrammatic longitudinal section view and a plan view of a second embodiment of the device in accordance with the invention in the unlatched position.

FIGS. 5A and 5B are a longitudinal section view and a diagrammatic plan view of the second embodiment of the device in accordance with the invention in the unlatched position.

FIGS. 6A and 6B are a longitudinal section view and a diagrammatic plan view of the second embodiment of the device in accordance with the invention in its cover-displaced position.

### MORE DETAILED DESCRIPTION

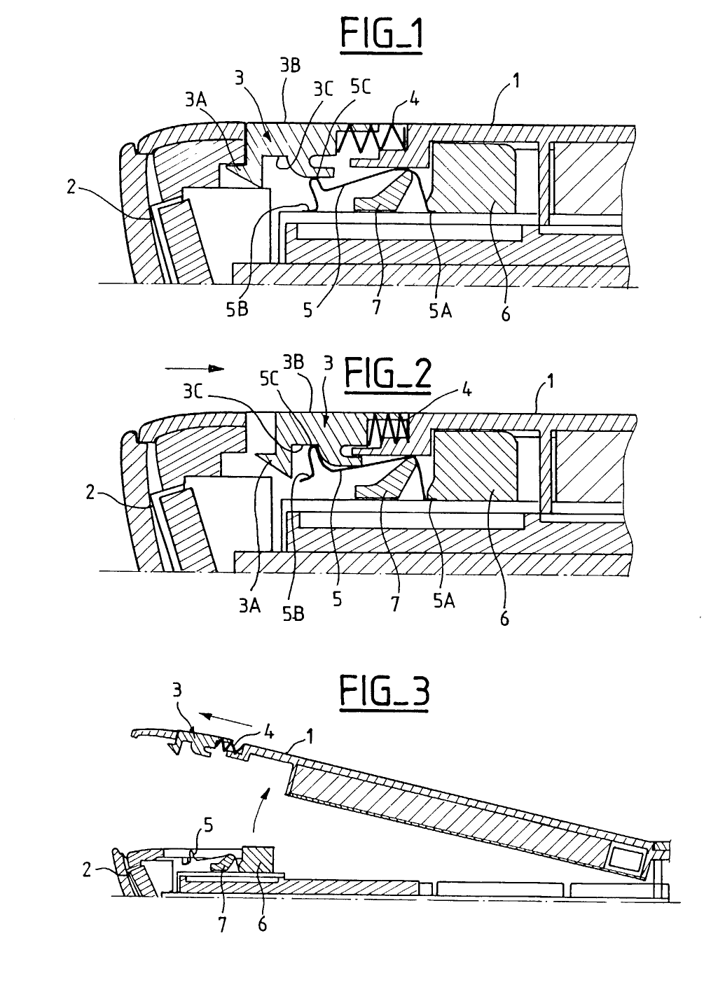

As shown in FIGS. 1 and 3, a removable cover 1 is mounted on a box 2 and is latched to said box 2 by a latch 3 itself mounted on the cover 1. The latch 3 slides parallel to the plane of the cover 1 from a latched position shown in FIG. 1 to an unlatched position shown in FIG. 2. In conventional manner, it is urged towards the latched position by a coil spring 4 placed at its end and bearing against the cover 1. At its opposite end, the latch 3 has a hook 3A which, in the latched position, engages beneath a portion of the box 2 so as to lock the cover to the box. When the latch is moved in translation, the hook 3A disengages from the box, thereby allowing the cover 1 to be moved.

The latch 3 has a gripping surface 3B for causing the latch to slide, and in general this surface presents molded ribs that ensure grip.

The cover 1 in this embodiment is moved by pivoting about its end remote from the latch, as can be seen in FIG. 3.

The latching and unlatching device includes means for locking the latch 3 in the unlatched position until the cover 1 has been moved, said locking means being deactivated as soon as the cover 1 has been moved.

The locking means is constituted by a spring arrangement 5.

The spring arrangement comprises a spring blade 5 secured to the box 2. This spring blade is of a shape such as to allow the latch to slide from the latched position to the unlatched position, in which it engages in a locking cavity formed in the cover.

More precisely, one end of the spring blade 5A is jammed in a portion 6 that forms part of the box 2. It is curved in shape so as to be received in a compressed configuration beneath the cover 1, and its other end SB is free. It presents a folded portion SC forming a projection directed towards the cover 1. Advantageously, it is supported by a portion 7 that is secured to the box 2.

It is the folded portion SC which is designed to engage in a cavity of the cover in the unlatched position.

More precisely, the latch 3 presents this locking cavity 3C located close to its end carrying the hook 3A.

The latching and unlatching device operates as follows:

When thrust is applied to the latch 3 via its gripping surface 3B it is pushed against the force of the spring 4 and the hook 3A disengages from the box. During this movement in translation, the spring 5 slides under the latch until its folded portion SC engages in the locking cavity 3C as shown in FIG. 2. The latch 3 is then locked in the unlatched position and there is no need for the user to hold it in the unlatched position. The cover can then be moved by being pivoted, and as it moves the blade 5 is disengaged from the cavity 3C so the latch returns automatically into the latched position under drive from the spring 4 as shown in FIG. 3. Given the shape of the hook 3A, the cover can be reclosed merely by being pushed back into the box, with the hook 3A then sliding over the box against the force from the spring 4 and then being latched in the box.

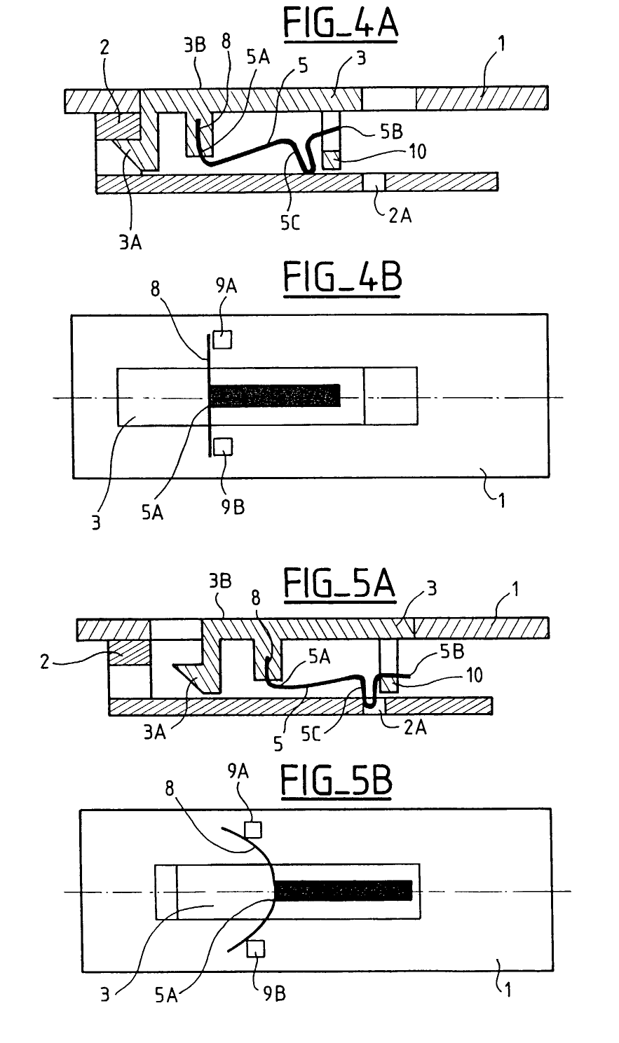

On equivalent lines, it is possible to shape the spring blade in such a manner as to enable it to serve both to lock the latch in the unlatched position and also to urge the latch into the latched position. An example of such an embodiment is described in FIGS. 4 to 6.

In this embodiment, the spring blade 5 is secured to the cover 1 and is of a shape such as to allow the latch 3 to slide from the latched position to the unlatched position, in which it engages in a cavity 2A formed in the box 2.

More precisely, one end of the blade SA is secured to a second spring blade 8 extending perpendicularly to the travel direction of the latch, when unstressed. The two blades 5 and 8 are preferably constituted by a single piece of cut and folded metal strip.

The blade 8 comes into abutment against two studs 9A and 9B arranged on the cover 1.

The blade 5 is of a curved shape so as to be received in a compressed configuration beneath the cover 1, and its end 5B is free. It has a folded portion SC forming a projection directed towards the box 2. Advantageously, it is supported by a portion 10 that is secured to the cover 1.

It is this folded portion SC that engages in the locking cavity 2A of the box in the unlatched position.

This latching and unlatching device operates as follows:

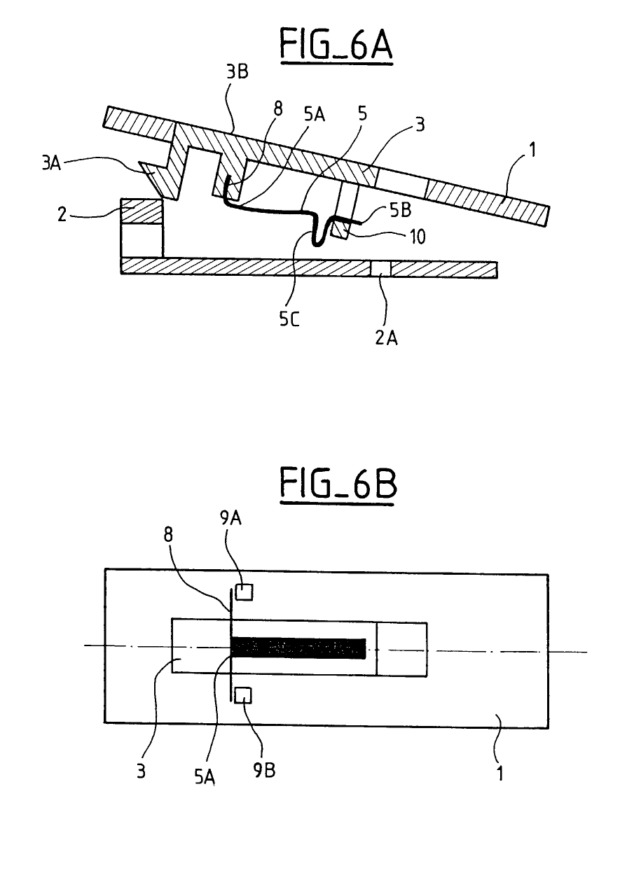

By applying thrust to the gripping surface 3B, the latch 3 is pushed against the force of the second blade 8 which deforms while remaining in abutment against the studs 9A and 9B, and the hook 3A is disengaged from the box. During this movement in translation, the blade 5 slides under the latch until its folded portion SC engages in the locking cavity 2A as shown in FIGS. 5A and 5B. The latch 3 is then locked in the unlatched position and there is no need for the user to hold it in the unlatched position. The cover can then be moved by being pivoted, and while it is moving the blade 5 becomes disengaged from the cavity 2A, so the latch returns automatically to its latched position under drive from the second blade 8 which returns to its rest position where it is still in abutment against the studs 9A and 9B, as shown in FIGS. 6A and 6B. Given the shape of the hook 3A, the cover can be reclosed merely by being pushed into the box, with the hook 3A sliding over the box against the force of the second blade 8, and then latching in the box.

With such an arrangement, it is optionally possible to add a compression spring secured to the cover to urge the latch towards the latched position.

In the above-described preferred embodiment, the resilient element 5 is a spring blade, but it is equally possible to use any other type of resilient element, such as a resilient wire or cable.

The preferred application of the latching and unlatching device described above lies in latching and unlatching the cover for a battery compartment in a portable telephone in a cellular or a fixed network. In the above description, the removable element 1 is said cover and the fixed element 2 is said battery compartment.

1/ A device for latching and unlatching a removable cover referred to as a “removable element” on a box referred to as a “fixed element”, the device comprising a latch provided on one of the elements and slidable between a latched position in which one end of the latch is in contact with the other element and unlatched position in which said end is not in contact with the other element, said latch having a gripping surface enabling it to be caused to slide, the device including means for locking the latch in the unlatched position at least until the cover has been moved, and wherein the locking means comprises a resilient element secured to one of the elements and engaging, in the unlatched position, in a locking cavity provided in the other element.

2/ A device according to claim 1, wherein said locking means is deactivated as soon as the cover has been moved.

3/ A device according to claim 1, wherein the cover is moved by pivoting about its end remote from the latch, and wherein the latch slides parallel to the plane of the cover.

4/ A device according to claim 1, wherein the resilient element is fixed to the box and is of a shape such as to allow the latch to slide from the latched position to the unlatched position in which it engages in a cavity formed in the cover.

5/ A device according to claim 4, wherein said resilient element is a spring blade and wherein one end of the blade is jammed in a portion secured to the box, the blade being of a curved shape so as to be received in a compressed configuration beneath the cover and presenting a folded portion forming a projection directed towards the cover, its other end being free.

6/ A device according to claim 1, wherein said resilient element is secured to the cover and is of a shape such as to allow the latch to slide from the latched position to the unlatched position in which it engages in a cavity formed in the box.

7/ A device according to claim 6, wherein said resilient element urges the latch towards its latched position until its reaches the unlatched position.

8/ A device according to claim 7, wherein said resilient element is a spring blade and wherein one end of said blade is secured to a second spring blade perpendicular to the travel direction of the latch when it is unstressed, and in abutment against two studs arranged on the cover, and said first-mentioned blade is of a curved shape so as to be received in a compressed configuration beneath the cover and presents a folded portion forming a projection directed towards the box, its end being free.

9/ A device according to claim 1, wherein a compression spring secured to the cover urges the latch towards the latched position.

10/ A portable telephone fitted with a latching and unlatching device according to claim 1, wherein said removable element is the cover a battery compartment forming said fixed element.
